(19) United States
(12) Patent Application Publication
(10) Pub. No.: US 2006/0108939 A1
(43) Pub. Date: May 25, 2006

(54) Plasma display panel, plasma display device including the same and driving method therefor

(76) Inventor: Tae-Kyoung Kang, Suwon-si (KR)

Correspondence Address: LEE & MORSE, P.C., 1101 WILSON BOULEVARD, SUITE 2000, ARLINGTON, VA, 22209, US

(21) Appl. No.: 11/283,708

(22) Filed: Nov. 22, 2005

(30) Foreign Application Priority Data
Nov. 25, 2004 (KR) 10-2004-0097366

(51) Int. Cl. G09G 3/10

(52) U.S. Cl. 315/169.4; 315/169.3; 313/583

(57) ABSTRACT

A plasma display panel plasma display panel includes first and second substrates facing each other, address electrodes extended in a first direction, barrier ribs disposed between the first and the second substrates to define discharge cells and display electrodes extended in a second direction crossing the first direction. The display electrodes have scan and sustain electrodes. The scan electrodes are drawn to a first periphery of the first and the second substrates to form scan electrode terminals. The sustain electrodes are coupled to a connection wire, and at least one of the sustain electrodes is drawn to the first periphery to form a sustain electrode terminal.

### BACKGROUND OF THE INVENTION

1. Field of the Invention

The present invention relates to a plasma display panel, a plasma display device with the panel and a driving method therefor. More particularly, the present invention relates to a plasma display panel having an improved terminal structure for display electrodes, a plasma display device with the panel and a driving method therefor.

2. Description of Related Art

Generally, a plasma display panel (PDP) is a display device which displays images by exciting phosphors with vacuum ultraviolet rays generated due to the gas discharge within the discharge cells. The PDP is flat, and enables the construction of a high resolution wide screen display. The PDPs are generally classified into an AC type and a DC type, in accordance with the driving voltage waveforms applied thereto and the discharge cell structure. AC PDPs having a three-electrode surface discharge structure have been widely adopted.

A conventional AC PDP includes a rear substrate and a front substrate facing each other and separated by a gap therebetween. Address electrodes, barrier ribs and phosphor layers are formed on the rear substrate, corresponding to respective discharge cells. Display electrodes are formed on the front substrate and are orthogonal to the address electrodes. The display electrodes functionally include a pair of scan and sustain electrodes. A dielectric layer covers the address and the display electrodes, and a discharge gas, e.g., a mixture gas of Ne—Xe, fills the interior of the discharge cells.

The conventional AC PDP is driven by a frame partitioned into a plurality of sub-fields. The respective sub-fields include a reset period, an address period and a sustain period.

The reset period initializes the state of the discharge cells such that the addressing operation is accurately performed in each discharge cell. The address period selects discharge cells to be turned on from all discharge cells by depositing wall charges in the selected discharge cells. The sustain period displays images in the selected discharge cells.

In order to achieve display, sustain discharge pulses are alternately applied to the scan and the sustain electrodes during the sustain period. In the reset and the address periods, the reset and the scan waveforms are applied to the scan electrodes. Accordingly, a scan driving board assembly for driving the scan electrodes and a sustain driving board assembly for driving the sustain electrodes are provided separately. Furthermore, a structure for connecting the scan electrodes to the scan driving board assembly and a structure for connecting the sustain electrodes to the sustain driving board assembly are also provided separately.

In the conventional AC PDP, the scan electrodes are drawn to one side of a periphery of the front substrate to form scan electrode terminals, and a flexible printed circuit (FPC) is coupled to the terminals to electrically connect the scan electrodes to the scan driving board. Furthermore, the sustain electrodes are drawn to an opposite side of the periphery of the front substrate to form sustain electrode terminals, and another FPC is coupled to the terminals to electrically connect the sustain electrodes to the sustain driving board.

In the conventional AC PDP constructed as described above, a scan driving board assembly and a sustain driving board assembly are separately installed in a chassis base. Furthermore, the FPCs are separately connected to the scan electrode terminals and the sustain electrode terminals. Accordingly, the processing steps are complicated, increasing the product cost.

### SUMMARY OF THE INVENTION

The present invention is therefore directed to a plasma display panel, a device having the plasma display panel and a driving method therefor, which substantially overcome one or more of the problems due to the limitations and disadvantages of the related art.

It is a feature of an embodiment of the present invention to provide a plasma display panel which has an integrated board for driving scan and sustain electrodes together.

It is another feature of the present invention to provide a display electrode terminal structure suited for use with an integrated board for driving scan and sustain electrodes together.

It is yet another feature of the present invention to provide a plasma display device with the panel having an integrated board for driving scan and sustain electrodes together.

It is still another feature of the present invention to provide a driving scheme for a plasma display panel having an integrated board for driving scan and sustain electrodes together.

At least one of the above and other features and advantages of the present invention may be realized by providing a plasma display panel, including first and second substrates facing each other, address electrodes between the first and second substrates, the address electrodes extending in a first direction, barrier ribs between the first and the second substrates, the barrier ribs defining discharge cells, display electrodes between the first and the second substrates, the display electrodes extending in a second direction orthogonal to the first direction and having scan and sustain electrodes, each discharge cell being between an address electrode and a display electrode, scan electrode terminals drawn from the scan electrodes to a first periphery of the first and the second substrates, a connector coupling the sustain electrodes, and a sustain electrode terminal drawn from at least one of the sustain electrodes to the first periphery.

The display electrodes may be separated into at least two electrode groups arranged in the first direction. The display electrodes may be coupled to separate connection units in respective electrode groups. At least one of two outermost sustain electrodes within one of the at least two electrode groups may be drawn to the first periphery to form the sustain electrode terminal. The plasma display panel may further include a display area and a non-display area surrounding the display area, wherein the scan and the sustain electrode terminals may be formed in the non-display area. At least some portions of the sustain electrodes may be in the non-display area and maybe formed with only bus electrodes. The first and the second substrates may include a second periphery opposite the first periphery. The connector may be formed in the non-display area close to the second periphery in the first direction, ends of the sustain electrodes extending toward the connector.

At least two meeting portions may be between the ends of the sustain electrodes and the connector. The display electrodes may be separated into at least two electrode groups arranged in the first direction. Respective meeting portions between the ends of two outermost sustain electrodes within one of the electrode groups and the connector may be rounded. The display may include a pair of first and second electrode groups arranged in the first direction, and outermost electrodes of the first electrode group and outermost electrodes of the second electrode group may differ from each other. The first and the second electrode groups may be separately coupled to the connection units different from each other.

At least one of the above and other features and advantages of the present invention may be realized by providing a plasma display device, including a plasma display panel comprising first and second substrates facing each other, barrier ribs disposed between the first and the second substrates to define discharge cells, a plurality of first and second electrodes formed corresponding to the discharge cells and a plurality of third electrodes formed in the direction crossing the first and the second electrodes, a chassis base having a first surface on which the plasma display panel is mounted, and a circuit board assembly mounted on a second surface of the chassis base, the second surface being opposite the first surface, the circuit board assembly including an integrated board assembly for driving both the first and second electrodes.

During a sustain period, the integrated board assembly may apply a driving voltage to the first electrodes while maintaining the second electrodes at a reference voltage. During the sustain period, the integrated board assembly may alternately apply a first voltage and a second voltage lower than the first voltage to the first electrode. A difference between the first voltage and the reference voltage may be equal to a difference between the second voltage and the reference voltage.

The first and second electrodes may be separated into at least two electrode groups arranged in the longitudinal direction of the third electrodes, and may include different connection units for separately coupling respective electrode groups to the integrated board assembly. The plasma display panel may include first electrode terminals drawn from the first electrodes to a first periphery of the first and the second substrates, a connector coupling the sustain electrodes, and a second electrode terminal drawn from at least one of the second electrodes to the first periphery. The integrated board assembly may be electrically connected to the first and second electrode terminals in the first periphery. The plasma display panel may include a display area and a non-display area surrounding the display area. The first and the second electrode terminals may be formed at the non-display area.

At least one of the above and other features and advantages of the present invention may be realized by providing a method of driving display electrodes of a plasma display panel during a sustain period, each display electrode having first and second electrodes, the method including alternately applying a first voltage and a second voltage to the first electrode, the second voltage being less than the first voltage and maintaining the second electrode at a third voltage throughout the sustain period.

A difference between the first and the third voltages may be equal to a difference between the second and the third voltages.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a plasma display device including a plasma display panel (PDP) according to first to fourth embodiments of the present invention;

FIG. 2 illustrates a partial exploded perspective view of an internal structure of a display area of the PDP of FIG. 1;

FIG. 3 illustrates a driving waveform chart applicable to PDPs according to first to fourth embodiments of the present invention;

FIG. 4 illustrates a plan view of a second substrate with display electrodes according to a first embodiment of the present invention;

FIG. 5 illustrates a partial enlarged view of the second substrate with display electrodes shown in FIG. 4;

FIG. 6 illustrates a plan view of the second substrate with display electrodes as shown in FIG. 4 with connection units;

FIG. 7 illustrates a partial plan view of a second substrate with display electrodes according to a second embodiment of the present invention;

FIG. 8 illustrates a partial plan view of a second substrate with display electrodes according to a third embodiment of the present invention; and

FIG. 9 illustrates a partial plan view of a second substrate with display electrodes according to a fourth embodiment of the present invention.

### DETAILED DESCRIPTION OF THE INVENTION

Korean Patent Application No. 10-2004-0097366 filed on Nov. 25, 2004, in the Korean Intellectual Property Office, and entitled, “Plasma Display Panel and Plasma Display Device Comprising the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, “wall charges” refer to charges formed on the wall, e.g., on a dielectric layer, of a discharge cell close to the respective electrodes. Although the wall charges do not actually contact the electrodes, they will be referred to herein as being “formed”, “accumulated”, or “deposited” on the electrodes. Furthermore, “wall voltage” refers to a potential difference formed on the wall of the discharge cell due to the wall charges.

Embodiments of an electrical interconnection for display electrodes of a plasma display panel (PDP) will be described below. Each display electrode includes a scan electrode and a sustain electrode. In accordance with embodiments of the present invention, the scan and sustain electrodes may be coupled with a common connection unit. In accordance with embodiments of the present invention, the scan and sustain electrodes may be coupled to a common board assembly. In accordance with embodiments of the present invention, the scan and sustain electrodes may have terminals on a same side of a periphery of the PDP. In accordance with embodiments of the present invention, the sustain electrodes may be maintained at a constant voltage.

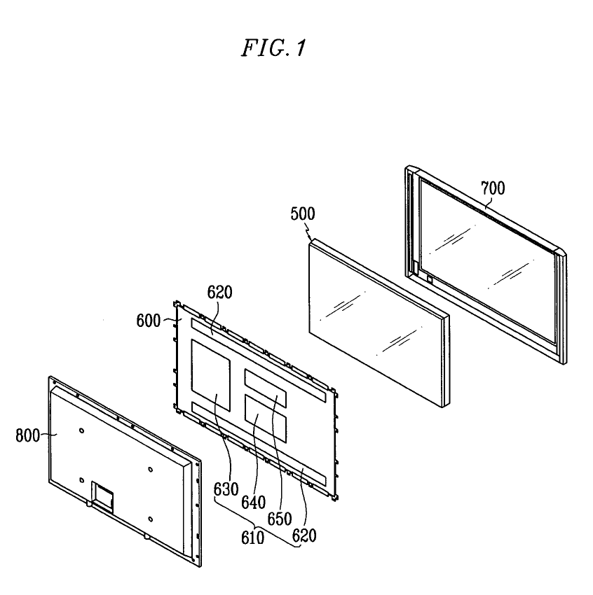

As shown in FIG. 1, a plasma display device includes a PDP 500, a chassis base 600, a front case 700 and a rear case 800. The chassis base 600 is placed opposite to the image display screen of the PDP 500, and combined with the PDP 500. The front case 700 is placed in front of the PDP 500 and the rear case 800 is placed behind the chassis base 600. The front and the rear cases 700 and 800 are combined with the PDP 500 and the chassis base 600, forming the plasma display device.

The PDP 500 may be attached to a front surface of the chassis base 600, i.e., facing the front case 700, and a plurality of circuit board assemblies 610 required for driving the PDP 500 may be mounted on a rear surface of the chassis base 600, i.e., facing the rear case 800. The plurality of circuit board assemblies 610 may include address buffer board assemblies 620, an integrated board assembly 630, an image processing and controlling board assembly 640 and a power supply board assembly 650. The following description of positions of the plurality of circuit board assemblies 610 is made with reference to the orientation shown in FIG. 1.

The address buffer board assemblies 620 may be formed on the top and the bottom of the chassis base 600, respectively. As shown in FIG. 1, each address buffer board assembly 620 may be formed with a single board assembly, but also may be formed with plural numbers of boards. Although a dual driving plasma display device is shown in FIG. 1 as an example, a single driving plasma display device may be introduced, in which the address buffer board assembly 620 is located at only the top or the bottom of the chassis base 600. The address buffer board assembly 620 may receive the address driving control signals from the image processing and controlling board assembly 640, and may apply a voltage for selecting discharge cells to be displayed to the respective address electrodes.

The integrated board assembly 630 may be located at the left side of the chassis base 600. The integrated board assembly 630 may be electrically connected to the scan and the sustain electrodes, and the sustain electrodes may be biased to a reference voltage, e.g., 0V. The integrated board assembly 630 may receive driving signals from the image processing and controlling board assembly 640, and may apply driving voltages to the scan electrodes while applying the reference voltage to the sustain electrodes. While the integrated board assembly 630 in FIG. 1 is located at the left side of the chassis base 600, it may be located at the right side of the chassis base 600.

The image processing and controlling board assembly 640 may receive external image signals, may generate control signals required for driving the address electrodes and control signals required for driving the scan electrodes, and may then apply corresponding voltages to the address driving board assembly 620 and the integrated board assembly 630, respectively. The power supply board assembly 650 supplies the power required for driving the PDP 500. The image processing and controlling board assembly 640 and the power supply board assembly 650 may be located at a center of the chassis base 600.

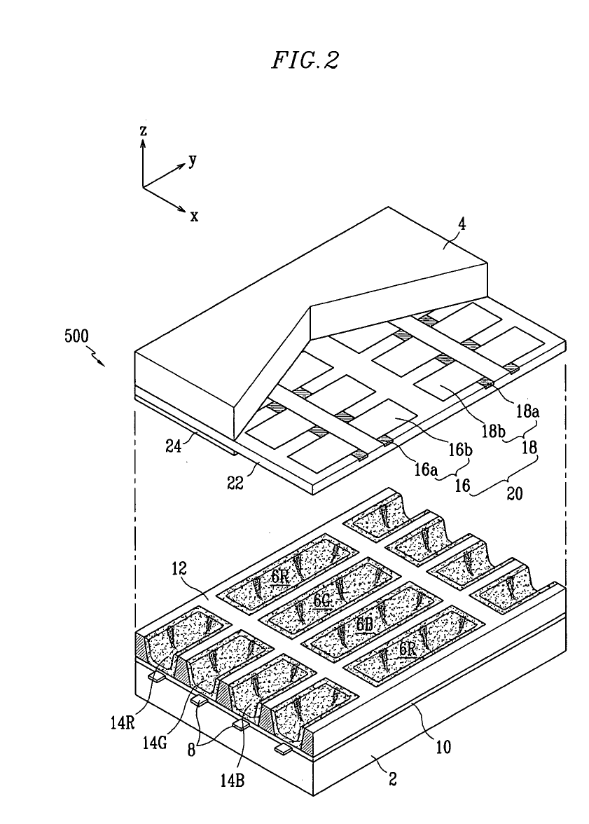

As shown in FIG. 2, the PDP 500 includes first and the second substrates 2 and 4 facing each other and separated by a gap. Discharge cells 6R, 6G and 6B may be provided between the two substrates. The respective discharge cells 6R, 6G and 6B emit visible light with a separate discharge mechanism thereof to display desired color images.

Address electrodes 8 may extend on an inner surface of the first substrate 2, i.e., a surface facing the second substrate 4, and may extend in a first direction, e.g., along the y axis of FIG. 2. A first dielectric layer 10 may be formed on the entire surface of the first substrate 2 to cover the address electrodes 8. The address electrodes 8 may be stripe-patterned, and arranged parallel to each other with a predetermined distance there between.

Barrier ribs 12 with a lattice shape may be formed on the first dielectric layer 10 to define the discharge cells 6R, 6G and 6B. A red, green or blue phosphor layer 14R, 14G or 14B may be formed on sidewalls of the barrier rib 12 and a top surface of the first dielectric layer 10. The barrier rib 12 is not limited to the above shape, but may be formed with other closed shapes or a stripe shape.

Display electrodes 20 may be formed on an inner surface of the second substrate 4 facing the first substrate 2 and may extend in a second direction crossing the first direction, e.g., along the x axis of FIG. 2. The display electrodes 20 may be formed with pairs of first electrodes 16 (referred to hereinafter as the “scan electrodes”) and second electrodes 18 (referred to hereinafter as the “sustain electrodes”). A transparent second dielectric layer 22 and a protective layer 24, e.g., an MgO layer, may be formed on the entire surface of the second substrate 4 to cover the display electrodes 20.

As shown in FIG. 2, the scan and sustain electrodes 16 and 18 may include bus electrodes 16a and 18a, and protrusion electrodes 16b and 18b, respectively. The bus electrodes 16a and 18a may be formed at the outer periphery of respective discharge cells 6R, 6G and 6B. The protrusion electrodes 16b and 18b may extend from the bus electrodes 16a and 18a, respectively, toward the interior of discharge cells 6R, 6G and 6B such that they face each other. The protrusion electrodes 16b and 18b may generate the plasma discharge within the discharge cells 6R, 6G and 6B. The protrusion electrodes 16b and 18b may be formed with a material for realizing a desired luminance, e.g., transparent indium tin oxide (ITO). However, the protrusion electrodes 16b and 18b may be formed with a non-transparent material, e.g., metal.

The first and the second substrates 2 and 4 may be sealed to each other at the peripheries thereof using a sealing member (not shown), e.g., a frit, and a discharge gas, e.g., a mixture gas of Ne—Xe, may fill the inner space between the substrates 2 and 4, thereby constructing the PDP 500.

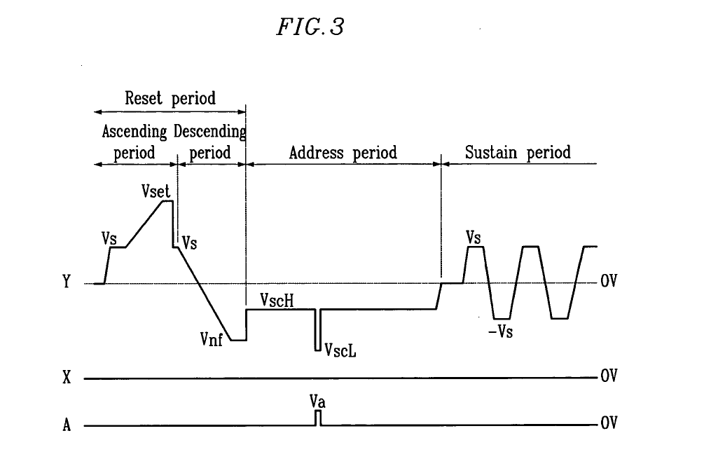

PDP driving waveforms applicable to the embodiments of the present invention will be explained with reference to FIG. 3. For explanatory convenience, a scan electrode (Y), a sustain electrode (X) and an address electrode (A) of a single discharge cell will be explained. Using the driving waveforms shown in the FIG. 3, voltages applied to the scan and the sustain electrodes may be supplied from an integrated board assembly, and voltages applied to the address electrode may be supplied from an address buffer board assembly. In this case, since only a first voltage (referred to hereinafter as the “reference voltage”), e.g., a ground voltage, is applied to the sustain electrode, explanation of voltage applied to the sustain electrode not be repeated.

As shown in FIG. 3, one sub-field may include a reset period, an address period and a sustain period. The reset period may include an ascending period and a descending period.

During the ascending period of the reset period, voltage applied to the sustain electrode is gradually increased from a voltage Vs to a voltage Vset, while the address electrode is maintained at the reference voltage, e.g., 0V. The voltage applied to the scan electrode may be linearly increased, e.g., in the form of a ramp. A slight discharge is made between the scan and the sustain electrodes as well as between the scan and the address electrodes while the voltage of the scan electrode is increased. Thus, negative (−) wall charges are formed on the scan electrodes, whereas positive (+) wall charges are formed on the sustain and the address electrodes. Since all discharge cells are to be initialized during the reset period, the voltage Vset is high enough for discharge to occur in all discharge cells, regardless of previous discharge cell conditions.

During the descending period of the reset period, voltage applied to the scan electrode is gradually reduced from the voltage Vs to a voltage Vnf. A slight discharge is made between the scan and the sustain electrodes as well as between the scan and the address electrodes, and the negative (−) wall charges formed on the scan electrode and the positive (+) wall charges formed on the sustain and the address electrodes are eliminated. Consequently, the wall voltage between the sustain and the scan electrodes becomes nearly 0V, and the discharge cells where the address discharge is not made during the address period are prevented from being inadvertently discharged during the sustain period.

Scan pulses with voltages VscL and address pulses with a voltage Va may then be applied to the scan and the address electrodes during the address period to select discharge cells to be turned on during the sustain period. The non-selected scan electrodes are biased to a voltage VscH, which is higher than the voltage VscL, and the reference voltage is applied to the address electrodes of the discharge cells not to be turned on. In the selected discharge cells, discharge occurs between the address and the scan electrodes so that positive (+) wall charges are formed on the scan electrodes, and negative (−) wall charges are formed on the address and the sustain electrodes. As a result, a wall voltage Vwxy is formed between the scan and the sustain electrodes such that the potential of the scan electrode is higher than the potential of the sustain electrode.

Thereafter, within the sustain period, pulses with the voltage Vs are applied to the scan electrodes at the selected discharge cells, thereby making the sustain discharge between the scan and the sustain electrodes. The voltage Vs is lower than a discharge firing voltage Vfxy between the scan and the sustain electrode, and the Vs+Vwxy voltage is higher than the Vfxy voltage. With the sustain discharge, negative (−) wall charges are formed on the scan electrodes, and positive (+) wall charges are formed on the sustain and the address electrodes such that the wall voltage Vwyx of the sustain electrode is higher than that of the scan electrode.

Thereafter, pulses with a third voltage which is lower than the voltage Vs, e.g., a voltage opposite, but equal to the voltage Vs (referred to hereinafter as the “voltage −Vs”), are applied to the scan electrode to make the sustain discharge between the scan and the sustain electrodes. As a result, positive (+) wall charges are formed on the scan electrodes, and negative (−) wall charges are formed on the sustain and the address electrodes. When the voltage Vs is applied to the scan electrodes, the sustain discharge may occur again. Thereafter, alternate application of the sustain discharge pulse of the voltage Vs and of the voltage −Vs to the scan electrode may be repeated a number of times in accordance with a weight indicated by the relevant sub-field.

The PDP according to embodiments of the present embodiment may be provided with an integrated board for driving the scan and the sustain electrodes together, in accordance with the previously described driving waveforms of FIG. 3. The realization of an integrated board in accordance with embodiments of the present invention may include driving the PDP where the reset pulse, the scan pulse, and the sustain discharge pulse are applied to the scan electrodes during the reset, address and sustain periods, respectively, while the sustain electrodes are only maintained at a predetermined reference voltage. Different embodiments of a terminal structure of the scan and the sustain electrodes that may be readily used with the integrated board will be now explained.

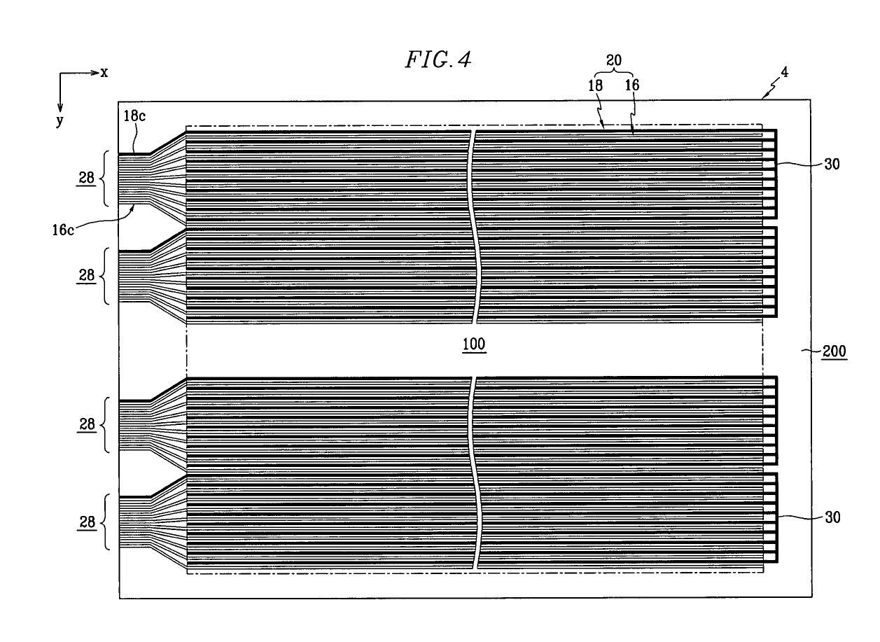

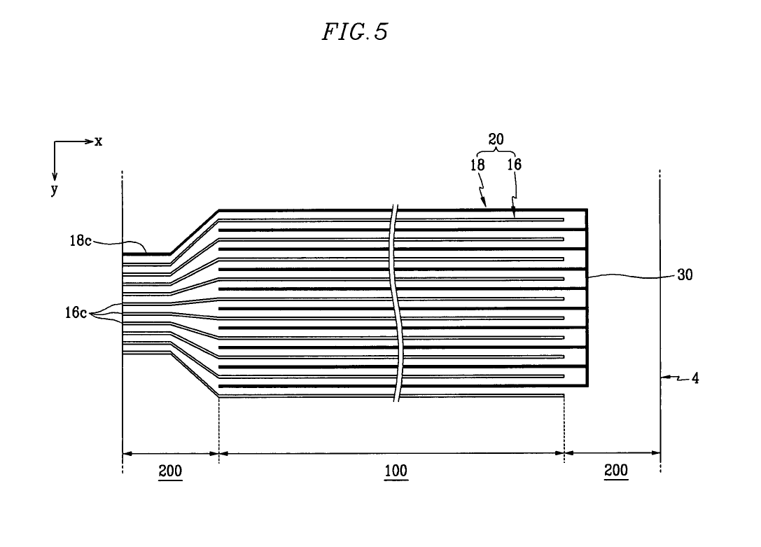

As shown in FIGS. 4 to 6, the PDP may have a display area 100, in which discharge cells for display are provided, and a non-display area 200 surrounding the display area 100. Scan electrode terminals 16c may be drawn out of the scan electrodes 16 in a first periphery of the second substrate 4, e.g., a left-side of the non-display area 200 as shown in FIG. 4. The sustain electrodes 18 may be electrically connected to each other via connection wires 30, and a sustain electrode terminal 18c may be drawn out of one of the sustain electrodes in the first periphery. The display electrodes 20 may be separated into at least two electrode groups 28 arranged in the longitudinal direction of the address electrodes, e.g., along the y axis of FIG. 4. The respective electrode groups 28 may each include a plurality of scan electrodes 16, a plurality of scan electrode terminals 16c, a plurality of sustain electrodes 18 and a sustain electrode terminal 18c. The sustain electrode terminal 18c may extend from at least one of the two outermost sustain electrodes 18, e.g., an uppermost sustain electrode in the FIGS. 4 and 5.

The sustain electrodes 18 in the respective electrode groups 28 may extend toward a second periphery of the second substrate 4, e.g., toward a right-side of the second substrate 4, so that ends of the sustain electrodes 18 are located at the non-display region 200. The connection wire 30 may be formed on the non-display area 200 in a direction perpendicular to the sustain electrodes 18, and connected to the ends of the sustain electrodes 18. In order to enhance the conductivity, some portions of the sustain electrodes 18 on the non-display area 200 may be formed only with bus electrodes.

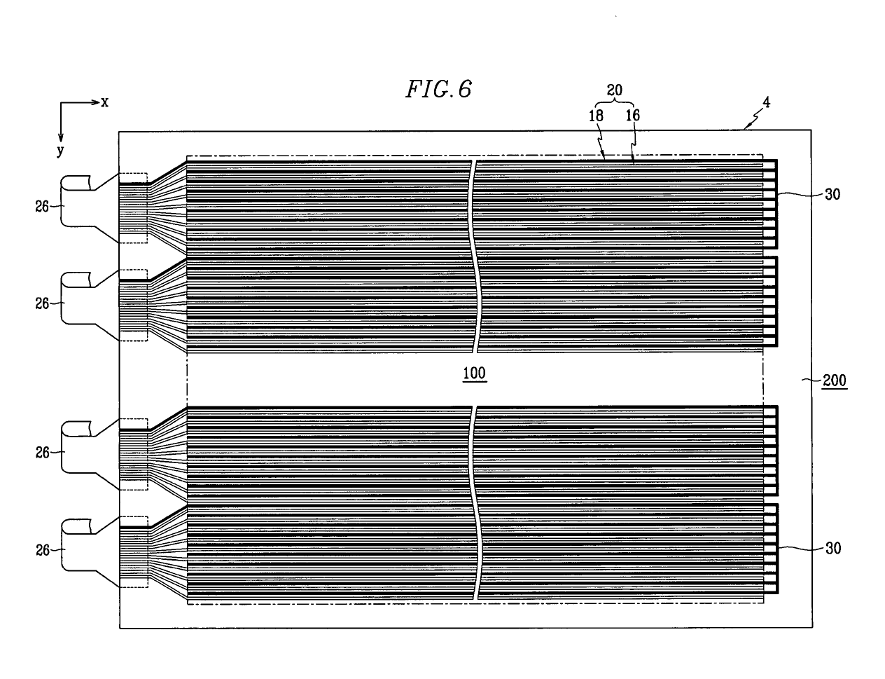

As shown in FIG. 6, a connection unit 26, e.g., a FPC, may be coupled to the scan electrode terminals and the sustain electrode terminal to provide voltages required for driving the PDP. For explanatory convenience, only the display electrode terminals and a connection unit coupled thereto are illustrated in FIG. 6.

The display electrodes 20 with the above-described terminal structure may be coupled to separate connection units 26 in respective electrode groups 28, and connected to the integrated board. That is, the scan electrode terminals 16c within an electrode group 28 and the sustain electrode terminal 18c within the same electrode group 28 may be coupled to a common connection unit 26, and connected to the integrated board. Accordingly, the number of connection units 26 may be reduced, simplifying processing and decreasing production cost.

The scan electrode terminals 16c coupled to a connection unit may have a reduced electrode pitch due an inclined portion. Consequently, the scan electrode terminals 16c may have an electrode pitch smaller than the pitch of the electrodes at the display area 100.

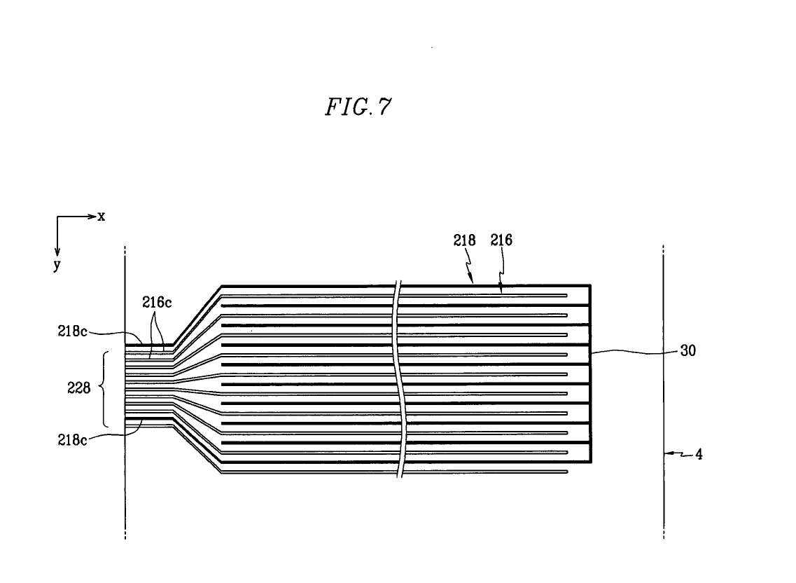

As shown in FIG. 7, in a PDP according to a second embodiment of the present invention, sustain electrode terminals 218c may extend from two outermost sustain electrodes 218 among the sustain electrodes 218 within one electrode group 228. In other words, sustain electrode terminals 218c may be drawn out of the two outermost sustain electrodes 218 to the periphery of the second substrate 4 in the direction of scan electrode terminals 216c. Accordingly, the two sustain electrode terminals 218c at the respective electrode groups 228 may simultaneously receive the reference voltage from the integrated board.

The locations of the sustain electrodes 18 and 218 from which the sustain electrode terminals 18c and 218c are drawn within one electrode group 28 and 228 are not limited to those described above in connection with the first and second embodiments.

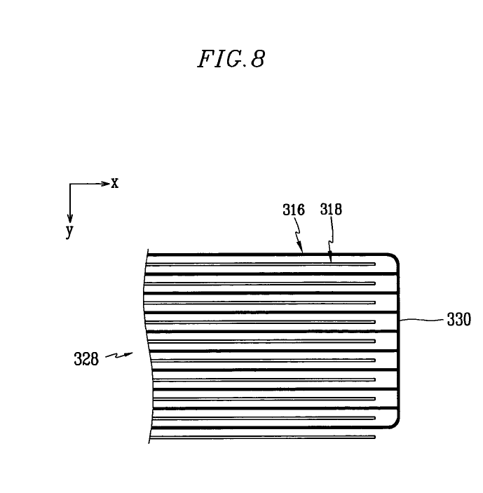

As shown in FIG. 8, a PDP according to a third embodiment of the present invention basically has a same structure as the first embodiment, except that at least two meeting portions between the ends of the sustain electrodes 318 and the connection wire 330 within the respective electrode groups 328 may be rounded with a predetermined curvature. As shown in FIG. 8, respective meeting portions between ends of the two outermost sustain electrodes 318 and the connection wire 330 within one electrode group 328 may be rounded.

When meeting portions between ends of the sustain electrodes 318 and the connection wire 330 are at a vertical angle to each other, the sustain electrodes 318 and the connection wire 330 may be cut during formation of an electrode pattern on the second substrate. That is, the electrode pattern formation may include forming an electrode material layer on the second substrate, and removing the electrode material layer at the unneeded portions through etching and developing. Such an electrode pattern formation may result in over-etching at the contact area between the sustain electrodes 318 and the connection wire 330, so that the sustain electrodes 318 and the connection wire 330 may be cut. However, with rounded meeting portions between the ends of the outermost sustain electrodes 318 and the connection wire 330 as shown in FIG. 8, the risk of cutting during electrode pattern formation may be reduced.

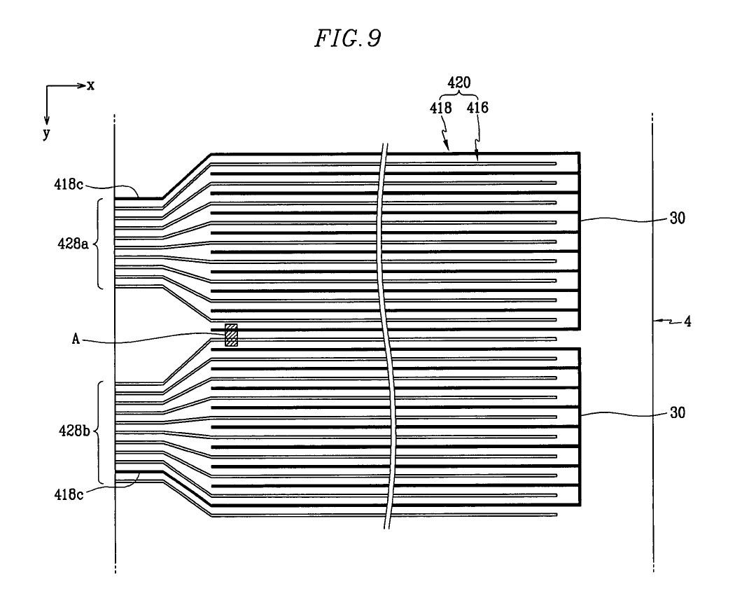

In a fourth embodiment of the present invention, as shown in FIG. 9, display electrodes 420 include a pair of a first electrode group 428a and a second electrode group 428b arranged in the direction of the y axis. The first and second electrode groups 428a and 428b may be connected to the integrated board via separate connection units. Outermost electrodes of the first electrode group 428a and of the second electrode group 428b may be different. In other words, an outermost electrode of the first electrode group 428a may be sustain electrodes 418, whereas an outermost electrode of the second electrode group 428b may be scan electrodes 416. At least one of the sustain electrodes 418 of the first electrode group 428a and at least one of the sustain electrodes 418 of the second electrode group 428b may be drawn to the first periphery of the second substrate 4 to form sustain electrode terminals 418c. In FIG. 9, a uppermost sustain electrode 418 of the first electrode group 428a and the bottommost sustain electrode 418 of the second electrode group 428b are drawn to thereby form the sustain electrode terminals 418c.

In the fourth embodiment, the sustain electrode 418 of the first electrode group 428a may be placed close to the second electrode group 428b and the scan electrode 416 of the second electrode group 428b may be placed close to the first electrode group 428a, thus forming one display electrode for a discharge cell, indicated by region A in FIG. 9.

As described above, in PDPs according to embodiments of the present invention, the scan electrode terminals and the sustain electrode terminals within one electrode group may be coupled to a common connection unit at one side of a periphery of the second substrate. Furthermore, the scan and the sustain electrodes may be connected to the integrated board via the common connection unit. Consequently, the number of connection units may be reduced, simplifying processing and decreasing production cost.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
first and second substrates facing each other;
address electrodes between the first and second substrates, the address electrodes extending in a first direction;
barrier ribs between the first and the second substrates, the barrier ribs defining discharge cells;
display electrodes between the first and the second substrates, the display electrodes extending in a second direction orthogonal to the first direction and having scan and sustain electrodes, each discharge cell being between an address electrode and a display electrode;
scan electrode terminals drawn from the scan electrodes to a first periphery of the first and the second substrates;
a connector coupling the sustain electrodes; and
a sustain electrode terminal drawn from at least one of the sustain electrodes to the first periphery.

2. The plasma display panel as claimed in claim 1, wherein the display electrodes are separated into at least two electrode groups arranged in the first direction.

3. The plasma display panel as claimed in claim 2, wherein the display electrodes are coupled to separate connection units in respective electrode groups.

4. The plasma display panel as claimed in claim 2, wherein at least one of two outermost sustain electrodes within one of the at least two electrode groups is drawn to the first periphery to form the sustain electrode terminal.

5. The plasma display panel as claimed in claim 1, further comprising a display area and a non-display area surrounding the display area, wherein the scan and the sustain electrode terminals are formed in the non-display area.

6. The plasma display panel as claimed in claim 5, wherein at least some portions of the sustain electrodes are in the non-display area and are formed with only bus electrodes.

7. The plasma display panel as claimed in claim 5, wherein the first and the second substrates comprise a second periphery opposite the first periphery, wherein the connector is formed in the non-display area close to the second periphery in the first direction, ends of the sustain electrodes extending toward the connector.

8. The plasma display panel as claimed in claim 7, wherein at least two meeting portions between the ends of the sustain electrodes and the connector.

9. The plasma display panel as claimed in claim 7, wherein the display electrodes are separated into at least two electrode groups arranged in the first direction, and respective meeting portions between the ends of two outermost sustain electrodes within one of the electrode groups and the connector are rounded.

10. The plasma display panel as claimed in claim 1, wherein the display electrodes comprise a pair of first and second electrode groups arranged in the first direction, and outermost electrodes of the first electrode group and outermost electrodes of the second electrode group differ from each other.

11. The plasma display panel as claimed in claim 10, wherein the first and the second electrode groups are separately coupled to the connection units different from each other.

12. A plasma display device, comprising:
a plasma display panel comprising first and second substrates facing each other, barrier ribs disposed between the first and the second substrates to define discharge cells, a plurality of first and second electrodes formed corresponding to the discharge cells and a plurality of third electrodes formed in the direction crossing the first and the second electrodes;
a chassis base having a first surface on which the plasma display panel is mounted; and
a circuit board assembly mounted on a second surface of the chassis base, the second surface being opposite the first surface, the circuit board assembly including an integrated board assembly for driving both the first and second electrodes.

13. The plasma display device as claimed in claim 12, wherein, during a sustain period, the integrated board assembly applies a driving voltage to the first electrodes while maintaining the second electrodes at a reference voltage.

14. The plasma display device as claimed in claim 13, wherein during the sustain period, the integrated board assembly alternately applies a first voltage and a second voltage lower than the first voltage to the first electrode.

15. The plasma display device as claimed in claim 14, wherein a difference between the first voltage and the reference voltage is equal to a difference between the second voltage and the reference voltage.

16. The plasma display device as claimed in claim 12, wherein the first and the second electrodes are separated into at least two electrode groups arranged in the longitudinal direction of the third electrodes, and further comprising different connection units for separately coupling respective electrode groups to the integrated board assembly.

17. The plasma display device as claimed in claim 12, wherein the plasma display panel includes first electrode terminals drawn from the first electrodes to a first periphery of the first and the second substrates, a connector coupling the sustain electrodes, and a second electrode terminal drawn from at least one of the second electrodes to the first periphery, the integrated board assembly being electrically connected to the first and second electrode terminals in the first periphery.

18. The plasma display device as claimed in claim 17, wherein the plasma display panel comprises a display area and a non-display area surrounding the display area, and the first and the second electrode terminals are formed at the non-display area.

19. A method of driving display electrodes of a plasma display panel during a sustain period, each display electrode having first and second electrodes, the method comprising:
alternately applying a first voltage and a second voltage to the first electrode, the second voltage being less than the first voltage; and
maintaining the second electrode at a third voltage throughout the sustain period.

20. The method as claimed in claim 18, wherein a difference between the first and the third voltages is equal to a difference between the second and the third voltages.
